(19) United States
(12) Patent Application Publication
(10) Pub. No.: US 2024/0403936 A1
(43) Pub. Date: Dec. 5, 2024

(54) FRIENDSHIP-BASED RECOMMENDER SYSTEM

(71) Applicant: INTUIT INC., Mountain View, CA (US)

(72) Inventor: Yaakov TAYEB, Tzur Hadassa (IL)

(21) Appl. No.: 18/325,568

(22) Filed: May 30, 2023

(51) Int. Cl. G06Q 30/0601

(52) U.S. Cl. CPC G06Q 30/0631

(57) ABSTRACT

The present disclosure provides techniques for friendship-based automated recommender system. One example method includes receiving electronic record data indicating interactions between a plurality of users and a plurality of providers, constructing a bipartite graph based on the interactions, identifying, for each user of the plurality of users, a set of other users in the plurality of users, adding to the bipartite graph, for each user of the plurality of users, intra-user edges between the user and the set of other users, computing, for each respective intra-user edge of the intra-user edges, a weight of the respective intra-user edge, computing, for each respective user of the plurality of users, a popularity score, computing, for each respective provider of the plurality of providers, a reputation score, and training a recommender system using the reputation scores of the plurality of providers, wherein the recommender system is used to automatically determine a provider recommendation.

### INTRODUCTION

Aspects of the present disclosure relate to a friendship-based automated recommender system.

Every year millions of people, businesses, and organizations around the world utilize software applications to assist with countless aspects of life. Many software applications provide automated recommendation functionality, such as providing users with automatically-determined recommendations of content, products, or services. Such automated recommendation functionality is generally based on information provided by the user and activities performed by the user within the application.

However, existing recommender systems for automatically recommending products and services are generally constrained by information known about a given user, and are limited in their ability to determine the quality or reputation of recommended items beyond user-provided ratings. For example, content-based filtering uses similarity between items to recommend items similar to what a user likes. Similarly, collaborative filtering can recommend an item to a user based on the interests of another user that is determined to be similar to the user. In addition, recurrence-based methods consider the number of interactions that a user has with a provider or the reviews from the user on the provider. However, these existing methods often result in recommending content, products, or services that are only weakly linked to a user and/or that are of low quality or reputation and therefore are unlikely to be considered useful or relevant.

Accordingly, improved systems and methods are needed for determining automated recommendations in software applications.

### BRIEF SUMMARY

Certain embodiments provide a method for friendship-based automated recommendations. The method generally includes receiving electronic record data indicating interactions between a plurality of users and a plurality of providers, constructing a bipartite graph based on the interactions, wherein one set of nodes of the bipartite graph represents the plurality of users and another set of nodes of the bipartite graph represents the plurality of providers, and wherein an edge connects each respective provider of the plurality of providers with each respective user of the plurality of users that interacted with the respective provider in the interactions, identifying, for each user of the plurality of users, a set of other users in the plurality of users, wherein each given user in the set of other users interacted with at least one common provider that the user interacted with in the interactions, adding to the bipartite graph, for each user of the plurality of users, intra-user edges between the user and the set of other users in the plurality of users, computing, for each respective intra-user edge of the intra-user edges, a weight of the respective intra-user edge based on a number of common providers shared by a pair of users of the plurality of users that is connected by the respective intra-user edge, computing, for each respective user of the plurality of users, a popularity score, based on the weights of the intra-user edges connected to the respective user, computing, for each respective provider of the plurality of providers, a reputation score based on the popularity scores of respective users of the plurality of users that are connected to the respective provider, and training a recommender system using the reputation scores of the plurality of providers, wherein the recommender system is used to automatically determine a provider recommendation.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example preprocessor for a friendship-based automated recommender system.

FIG. 2 depicts an example graph for a friendship-based automated recommender system.

FIG. 3 is a flow diagram of example operations for a friendship-based automated recommender system.

FIG. 4 depicts an example application server related to embodiments of the present disclosure.

### DETAILED DESCRIPTION

Aspects of the present disclosure provide apparatuses, methods, processing systems, and computer-readable mediums for a friendship-based automated recommender system.

Existing techniques for generating automated recommendations in software applications, such as content-based filtering, collaborative filtering, and recurrence-based methods, are often based on interactions between users and providers. However, these techniques generally ignore the interactions among users and do not reveal how the preferences or actions of a user impact another user. Although recurrence-based methods can utilize the number of purchases or reviews from users, they do not analyze how the review or purchase from one user impacts another user. In addition, recurrence-based methods are prone to reliance on fake reviews and do not give a reliable assessment of recommendations from users on providers. The shortcomings of the existing automated recommendation techniques become more troublesome when the users are considering products or services that are for a specific time period or not purchased frequently, such as the purchase of a chandelier or the service of nannies for assistance with childcare.

While conventional recommender systems for recommending products or services to a user do not consider the impact of other users related to a user (e.g., friends of the user) on the user, embodiments of the present disclosure involve training a recommender system by assessing the impact of friends on the preferences of a user and finding providers favored by influential individuals who impact the preferences of friends, so as to provide more targeted, relevant, and high-quality automated recommendations.

Interactions (e.g., purchases, transactions, comments, reviews, and so on) between users and providers can be used to analyze the relationships (e.g., connections) between them. For example, appropriate tools (e.g., a graph, an adjacency matrix, and/or the like) can be utilized to study the relationships between the users and the providers. In turn, the interactions between users and providers can provide valuable data related to the interactions among users.

Users generally make purchasing decisions under the influence of a group of friends, who are considered reliable sources of information. This phenomenon is more evident with respect to products or services that users purchase only once or otherwise purchase infrequently, as discussed above. Furthermore, the preferences of a user can change under the suggestions of her or his friends. For example, a user may first try and then frequent a restaurant after a friend recommends the restaurant to the user. However, users exert different degrees of influence on one another. For example, within a group of friends, a particular user may exert greater influence on the other users in the group. The particular user may lead the trend and whatever she or he recommends would be very likely to be purchased and liked by a majority of users in the group of friends. As such, the particular user may be regarded as an influential user.

The influence that users exert on one another can be automatically uncovered using techniques described herein from analyzing intra-user relationships evidenced by electronic data, such as electronic records of interactions between users and providers and among users. The intra-user relationships can be assessed based on the connections of users to common providers. For example, for each pair of users, the number of common providers shared by the users can be used to compute a degree of connectivity (e.g., a weight of an edge) between the pair of users, which can indicate the influence that one user has on the other, or that the pair of users have on each other.

The degrees of connectivity between pairs of users can be used to compute popularity scores of users, which may represent the impacts of users on the preferences of other users. The popularity score of a user can be computed as an average of the degrees of connectivity from the user to other users. Influential users often have high popularity scores.

The popularity scores of users can used to compute reputation scores of providers, which may indicate how highly the provider is favored (e.g., recommended) by users. The reputation score of a provider may be computed by averaging the popularity scores of users that interact with the provider.

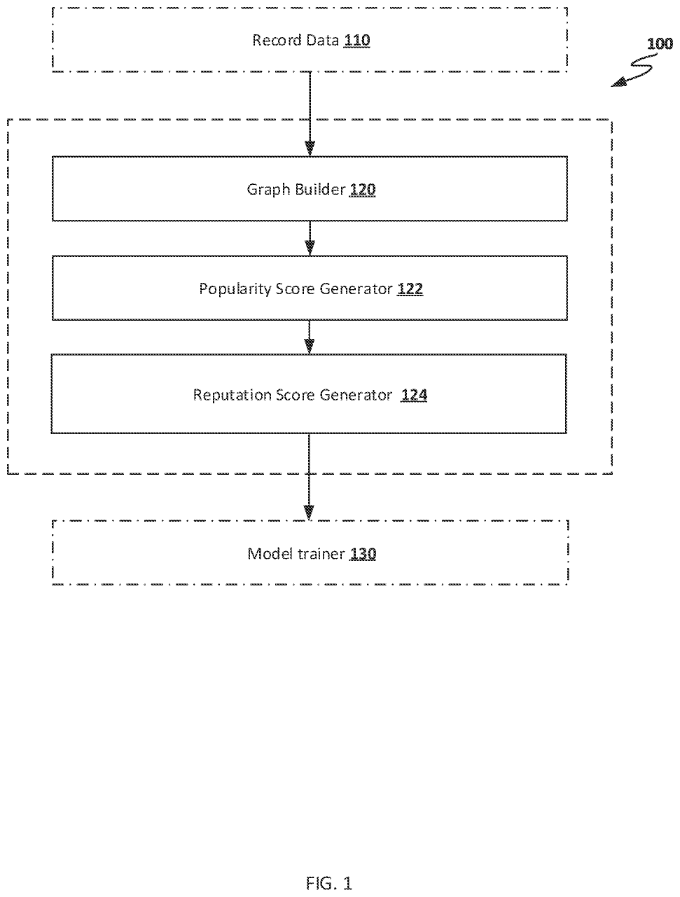

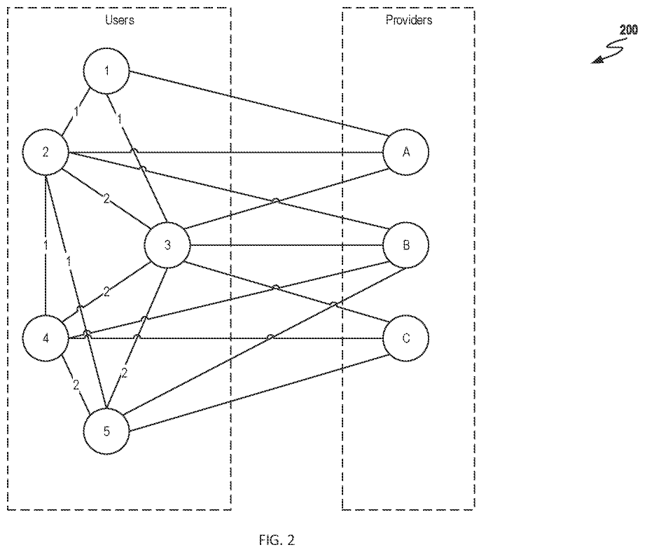

Details regarding the degrees of connectivity between users, the popularity scores of users, and the reputation scores of providers can be found below with respect to FIGS. 1-2.

The reputation scores of the providers can be used to train a recommender system to recommend a relevant and reputable provider for a given user (e.g., by re-ranking the providers recommended to the given user). In some examples, features related to the delivery capacities of the provider are combined with the reputation score of the provider to train the recommender system. By including the features related to the delivery capacities of the provider, the recommender system can account for the reliability of the provider to deliver products or services. For example, in certain cases, a provider with higher capacity to deliver and a lower reputation score may be recommended instead of another provider with lower capacity to deliver and a higher reputation score, such that the user who receives the recommendation can have timely delivery of products or services.

In some examples, additionally, features related to the profiles of the users who interact with the provider are also combined with the reputation score of the provider to train the recommender system. By including features related to the profiles of the users, the recommender system can account for the specific preferences of the users. For example, though provider A has a better reputation score but is expensive, provider B that has a slightly lower reputation score but is cheaper can be recommended to a user with a lower purchasing power (e.g., as indicated in features related to the profile of the user).

Accordingly, by accounting for the relationships between users and the influence that users have on each other, techniques described herein train an accurate recommender system that considers the influences among user groups. In addition, incorporating the features related to the delivery capacities and user profiles of the providers can discount certain unfavorable factors (e.g., slow fulfilment of orders) and tune the recommendation system to the preferences of certain users. As a result, the trained recommender system can provide targeted recommendation relevant to the preferences of users and that consider important reputational factors related to providers, thereby improving user experience and reducing waste of computational resources. For example, by avoiding recommending providers that are unlikely to be selected by a user through techniques described herein for extracting latent information about the influence among users from electronic data, embodiments of the present disclosure avoid unnecessary utilization of computing resources associated with such suboptimal recommendations and improve the accuracy of an automated recommender system.

### Example Preprocessor for Friendship-based Recommender System

FIG. 1 depicts an example preprocessor 100 for a friendship-based automated recommender system. Although discussed with respect to analysis performed with a graph representation, preprocessor 100 can analyze data with the help of other appropriate data structures, such as an adjacency matrix or an adjacency list. In addition, though discussed with respect to an undirected graph, preprocessor 100 can perform analysis on directed graphs as well.

Preprocessor 100 receives record data 110 as the input. Record data 110 can indicate interactions between a plurality of users and a plurality of providers (e.g., of products or services). Each record of record data 110 indicates one interaction between a user and a provider. For example, record data 110 can include transactions, where each transaction represents an interaction between a user and a provider. In some examples, record data 110 is electronic data.

Record data 110 can be provided as the input to graph builder 120 to generate a graph. Graph builder 120 can first construct a bipartite graph where one set of nodes of the graph represent the users and another set of nodes of the graph represent the providers. Graph builder 120 can connect an edge between a user and a provider if record data 110 indicates one or more interactions between the user and the provider. For example, even if a user makes multiple purchases from a provider, there is only one edge connecting the user and the provider.

Graph builder 120 can then identify for a user a set of other users who interact with at least one common provider that the user interacts with. For example, graph builder 120 can identify, for a user who made purchases at a shop, a set of other users who also made purchases at the shop. Graph builder 120 can find the set of other users using the edges connecting a common provider to the users.

In some examples, the identification of the set of other users is performed based on a matrix (e.g., an adjacency matrix) that can be represented using an appropriate data structure (e.g., a matrix, a Pandas Dataframe and/or the like). Details regarding identifying the set of other users can be found below with respect to FIG. 2.

Graph builder 120 can further add to the graph, for each user, intra-user edges between the user and the set of other users. In an example, if user X and user Y are both connected to at least one common provider, an edge is added between user X and user Y.

Graph builder 120 can then compute a weight for each intra-user edge. The weight for an intra-user edge can represent a degree of connectivity that a pair of users have with respect to each other, such as the influence that one user has on the other. For a given pair of users, the weight of the intra-user edge can be computed by counting the number of common providers that the given pair of users shares. Following the example above, user X and user Y share 3 common providers. Accordingly, the weight of the intra-user edge between user X and user Y is 3.

The graph with the computed weights of the intra-user edges can be provided to a popularity score generator 122 to compute the popularity score of each user. The popularity score of a user may indicate the impact that the user has on other users. For example, users with high popularity scores may represent those whose opinions are more valued or have higher impact on others. High impact users can be leaders of a group of friends, key opinion leaders, influencers, and so on, who may significantly influence the preferences of others. The popularity score can be computed in a variety of ways, such as by averaging (e.g., computing a mean, a median, a weighted average, and/or the like) the weights of intra-user edges connected to the user. It is noted that alternative techniques for calculating the popularity score are possible, such as a sum or a max of the weights of the intra-user edges connected to the user.

However, in some examples, random occurrences (e.g., marketing campaigns by the providers) may affect the data. For example, two users sharing only one common provider are more likely to be strangers who marginally impact the preferences of each other or have no impact on one another at all, rather than friends who share preferences for only one provider. To discount the impact of such random occurrences, in some embodiments, if a weight of an intra-user edge connected to the user does not meet a threshold weight, the weight of the intra-user edge may be set to (e.g., reassigned to or regarded as) zero during the computation of the popularity score of the users. The threshold weight can be static (e.g., a fixed numerical value, such as 3) or dynamic (e.g., as a percentile of all the weights of the intra-user edges, such as the 25th percentile). Details regarding computing the popularity score of a user can be found below with respect to FIG. 2.

The graph with the popularity scores of the users can be provided as the input to reputation score generator 124 to compute a reputation score of each provider. The reputation score of a provider may indicate the preference of the users on the provider. For example, providers with high reputation scores may represent those preferred by users, especially the high impact users. The reputation score of a provider can be computed in a variety of ways, such as by averaging (e.g., computing a mean, a median, a weighted average, and/or the like) the popularity scores of users connected to the provider. Details regarding computing the reputation score of a provider can be found below with respect to FIG. 2.

The reputation scores of the providers can be provided to model trainer 130 to train a recommender system. The recommender system may be used to automatically determine a provider recommendation to a given user. For example, the recommender system can re-rank the providers recommended to the given user according to the reputation scores of the providers. In some examples, the recommender system includes one or more machine learning models, which may, for example, include one or more of a linear regression model, a logistic regression model, a neural network, a reinforcement learning model, or a gradient-boosted tree.

In some example, the reputation score for each provider is combined with one or more attributes, such as a of a change in yearly income (e.g., revenue) of the provider, a change in net profit margin of the provider, a change in gross margin of the provider, a change in sales revenue of the provider, a category of the provider, or a geographical location of the provider, to generate a set of features. These features related to the delivery capacities (e.g., capacities to fulfill orders timely) of the providers can help re-rank the provider based on user preferences and attributes.

In an example, when a user prefers timely arrival of orders to other factors, a provider that is more highly preferred by high impact users but less likely to fulfill orders on time is ranked lower than another provider that is less highly preferred by high impact users but more likely to fulfill orders on time.

In some examples, additionally, the set of features is generated by further combining one or more additional attributes, such as an average age of the users who interact with the provider, an average income of the users who interact with the provider, a geographical location of the users who interact with the provider. These features related to the profiles of users at the providers can embed specific preferences (e.g., preference for timely arrival of orders, as discussed above) of the users and help the recommender system to re-rank providers so as to provide more relevant provider recommendations according to the preferences of a user.

As such, model trainer 130 can take the combined set of features to train the recommender system, instead of just the reputation scores of the providers. In one example, reputation scores of providers are used as an input feature to a machine learning model along with other features related to a user and a provider, and the machine learning model outputs a match score for the user and the provider. For example, training the recommender system may involve training a machine learning model using supervised learning techniques based on a training data set, where each training data instance in the training data set includes features of a given user and a given provider (e.g., including a reputation score of the provider determined using techniques described herein) associated with a label indicating whether the given provider is a match for the given user (e.g., based on the given user having historically interacted with the given provider). Supervised learning generally involves providing training inputs to a model, receiving outputs from the model based on the training inputs, and iteratively adjusting parameters of the model based on comparing the outputs to labels associated with the training inputs in the training data. It is noted that other techniques for training the recommender system are possible. For example, reputation scores of providers may be used as filtering criteria rather than or in addition to using reputation scores as input features to a machine learning model, such as excluding providers with reputation scores below a threshold. In one example, providers with a reputation score below a threshold are not recommended to users regardless of whether such providers are otherwise determined to be relevant to the users. In some embodiments, rules are used in conjunction with or instead of one or more machine learning models in order to automatically select providers to recommend to users. For example, rules may relate to reputation scores of providers and/or other factors discussed herein related to providers and users.

The recommender system trained using at least the reputation scores of the providers considers the impact of preferences of a user on the preferences of other users. By assessing this impact, the recommender system can provide more personalized recommendations of relevant providers to users, improve user experience, avoid unnecessary utilization of computing resources associated with providing suboptimal recommendations, and provide insight into the reputations of providers that existing automated recommendation systems are unable to provide.

### Example Graph for Friendship-Based Recommender System

FIG. 2 depicts an example graph 200 for a friendship-based automated recommender system. As depicted, each node of graph 200 indicates either a user or a provider. Although illustrated as including specific sets of users and providers, graph 200 can include fewer or more users or providers, respectively. In addition, though specific edges are depicted in graph 200, graph 200 can include fewer or more edges. Furthermore, although depicted as an undirected graph, graph 200 can be a directed graph as well.

As depicted, graph 200 includes two sets of nodes, namely one set of user nodes and another set of provider nodes. As depicted, nodes 1-5 are user nodes, also referred to as users 1-5, whereas nodes A-C are provider nodes, also referred to as providers A-C.

Graph 200 can be generated by a graph builder, such as graph builder 120 as depicted in FIG. 1. As illustrated, graph 200 includes two types of edges, namely edges between user nodes and provider nodes and intra-user edges between user nodes. As depicted, intra-user edges have associated weights that represent the impact that users have on other connected users, respectively.

Graph 200 can be first constructed based on one or more interactions between a set of users and a set of providers as indicated in electronic records of interactions, such as record data 110 of FIG. 1. As such, a bipartite graph including user nodes, provider nodes, and edges between user nodes and provider nodes can first be constructed. In this example, an edge is added between a user node and a provider node if the user has interacted with the provider, regardless of the number of interactions. For example, user 1 interacts with provider A, and an edge is added between user 1 and provider A.

Intra-user edges between pairs of users can then be added to the bipartite graph. The weight of an intra-user edge can indicate the number of common providers shared by the corresponding pair of users. The more common providers a pair of users share, the higher the weight of the intra-user edge between the pair of users will be. In this example, user 1 and user 2 share only 1 common provider, namely provider A. As such, an intra-user edge with a weight of 1 can be added between user 1 and user 2. Similarly, as depicted, the intra-user edge between user 3 and user 4 has a weight of 2 as user 3 and user 4 share 2 common providers, namely providers B and C. The weight of an intra-user edge can indicate how much influence a user has on the other user or the pair of users have on each other.

In some examples, the edges can be added and the weights of the intra-user edges can be determined using appropriate data structures, such as adjacency matrices. For example, an adjacency matrix can be constructed to denote the connections between users and providers (e.g., as indicated by the edges connecting users to providers), where one dimension (e.g., the rows) can denote the users and the other dimension (e.g., the columns) can denote the providers. In an example, a row denotes a particular user in terms of the providers that the particular user has interacted with, and similarly, a column denotes a particular provider in terms of the users who have interacted with the particular provider. The adjacency matrix may be binary and an entry of the matrix may indicate whether there was an interaction (e.g., using 1) between a particular user and a particular provider or not (e.g., using 0). Accordingly, the adjacency matrix can be used to add edges between user nodes and provider nodes so as to construct the bipartite graph discussed above.

Intra-user edges can also be added to graph 200 based on the adjacency matrix discussed above. Following the example above, if two distinct rows representing two users have an intersection of providers (e.g., determined using a logical AND operation), an intra-user edge between the two users represented by the two distinct rows can be added to graph 200. In addition, weights of the intra-user edges can be computed using the adjacency matrix. Following the example above, the weight of the intra-user edge between the two users can be calculated as the number of the intersection of the providers (e.g., as a sum of the vector resulted from the logical AND operation).

In some examples, alternatively, the operations above are performed with respect to more adjacency matrices or other appropriate data structures, such as adjacency lists. For example, two adjacency matrices can be constructed, where a first adjacency matrix denotes denote the connections between users and providers (e.g., as indicated by the edges connecting users to providers) as discussed above, and a second adjacency matrix denotes denote the connections among users (e.g., as indicated by the intra-user edges). A given entry of the second adjacency matrix can denote the number of common providers interacted by a pair of particular users and help compute the weight of a corresponding intra-user edge.

The weights of the intra-user edges are used to compute popularity scores for the users, as discussed with respect to popularity score generator 122 depicted in FIG. 1. The popularity score of a user can be computed as an average (e.g., a mean, a median, or a weighted average) of the weights of the connected intra-user edges. In this example, the popularity scores of users 1-5 are computed as the mean of the weights of the connected intra-user edges to be 1, 1.25, 1.75, 1.67, and 1.67, respectively. The popularity score of a user can indicate the influence a user has on other users. For example, user 3 has the highest popularity score among the users, and can be regarded as the most influential user among users 1-5.

The popularity scores of the users are then used to calculate the reputation scores of the providers, as discussed with respect to reputation score generator 124 depicted in FIG. 1. The reputation score of a provider can be computed as an average (e.g., a mean, a median, or a weighted average) of the popularity scores of the connected users. For example, the reputation score of provider B may be computed as a mean of popularity scores of connected users (e.g., users 2-5) to be 1.59.

As discussed with respect to FIG. 1, the reputation score of a provider can be combined with features related to the delivery capacity of the provider to generate a set of features. The delivery capacity features can embed information about whether a provider can fulfill orders timely. In addition, features related to the profiles of the users who interact with the provider can be included in the set of features. The user profile features can indicate specific preferences or interests of a particular group of users in the provider. The combined set of features, instead of just the reputation scores, can be used to train a recommender system to provide a personalized recommendation about a relevant provider for a given user, as discussed with respect to model trainer 130 depicted in FIG. 1.

Following the discussion above, there may be some times that random occurrences, such as marketing campaigns, can create intra-user edges, even though there is little to no impact that connected users have on each other. To discount such random occurrences, a threshold weight is used to denoise the weights of the intra-user edges.

In some examples, if the weight of an intra-user edge does not meet a threshold weight, the weight of the intra-user edge is regarded as zero in the calculation of the popularity scores of users. This can help discount the effects of random occurrences. For example, user 1 may not be introduced to provider A due to the influence of user 3, but instead due to a commercial campaign by provider A. As such, the weight (e.g., 1) of the intra-user edge between user 1 and user 3 may not accurately indicate the influence that user 1 or user 3 has on the other. The threshold weight can be determined based on the weights of the intra-user edges. For example, the threshold weight can be static (e.g., a fixed numerical value, such as 3) or dynamic (e.g., as a percentile of all the weights of the intra-user edges, such as the 25th percentile).

In this example, the threshold weight is predetermined as 2. As such, when computing the popularity scores of users, weights of intra-user edges no more than 1 will be regarded as (e.g., set to or reassigned to) 0. For example, during the computation of the popularity score of user 3, the weight (e.g., 1) of the intra-user edge between user 1 and user 3 is regarded as 0, as the weight does not meet the threshold weight. As such, the popularity score of user 3 may be computed as 1.5 if the threshold weight of 2 is considered. The reputation scores of the providers can be computed accordingly.

In some examples, alternatively, the intra-user edges with weights not meeting the threshold weight are disregarded (e.g., treated as not existent) during the computation of popularity scores for users.

### Example Operations for Friendship-Based Recommender System

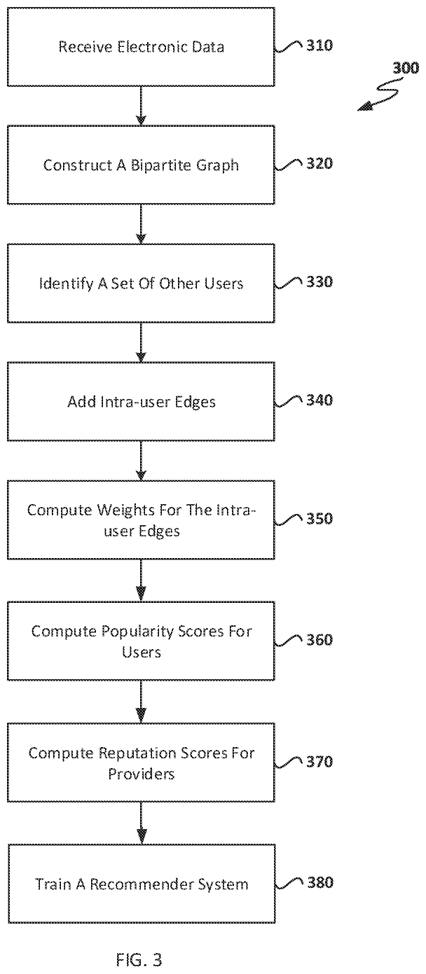

FIG. 3 is a flow diagram of example operations 300 for a friendship-based automated recommender system. Operations 300 may be performed by an extractor, such as preprocessor 100 as illustrated in FIG. 1.

Operations 300 begin at 310, where electronic record data indicating interactions between a plurality of users and a plurality of providers is received. For example, the electronic record data can be record data 110 illustrated in FIG. 1.

At 320, a bipartite graph is constructed based on the interactions, wherein one set of nodes of the bipartite graph represents the plurality of users and another set of nodes of the bipartite graph represents the plurality of providers, and wherein an edge connects each respective provider of the plurality of providers with each respective user of the plurality of users that interacted with the respective provider in the interactions. For example, the bipartite graph can be constructed by a graph builder, such as graph builder 120 as depicted in FIG. 1.

In some embodiments, an adjacency matrix is constructed based on the interactions, wherein one dimension of the adjacency matrix denotes the plurality of users and the other dimension denotes the plurality of providers. The adjacency matrix can be the adjacency matrix discussed with respect to FIG. 2.

At 330, for each user of the plurality of users, a set of other users is identified in the plurality of users, wherein each given user in the set of other users interacted with at least one common provider that the user interacted with in the interactions. For example, the identification can be performed by graph builder 120 as depicted in FIG. 1.

At 340, for each user of the plurality of users, intra-user edges is added to the bipartite graph between the user and the set of other users in the plurality of users. For example, the addition can be performed by graph builder 120 as depicted in FIG. 1. The resultant graph can be graph 200 as depicted in FIG. 2.

At 350, for each respective intra-user edge of the intra-user edges, a weight of the respective intra-user edge is computed based on a number of common providers shared by a pair of users of the plurality of users that is connected by the respective intra-user edge. For example, the weights of intra-user edges can be computed by graph builder 120 as depicted in FIG. 1. The weights of intra-user edges can be the same as or similar to the weights of intra-user edges in graph 200 as depicted in FIG. 2.

At 360, for each respective user of the plurality of users, a popularity score is computed based on the weights of the intra-user edges connected to the respective user. For example, the popularity scores of the plurality of users can be computed by popularity sore generator 122 as depicted in FIG. 1.

In some embodiments, wherein computing, for each respective user of the plurality of users, the popularity score, based on the weights of the intra-user edges connected to the respective user comprises determining that a weight of a particular intra-user edge connected to the respective user does not meet a threshold weight, setting the weight of the particular intra-user edge to zero, and computing an average weight based on the weights of the intra-user edges connected to the respective user.

At 370, for each respective provider of the plurality of providers, a reputation score is computed based on the popularity scores of respective users of the plurality of users that are connected to the respective provider. For example, the reputation scores of the plurality of providers can be computed by reputation sore generator 124 as depicted in FIG. 1.

In some embodiments, wherein computing, for each respective provider of the plurality of providers, a reputation score based on the popularity scores of the respective users of the plurality of users that are connected to the respective provider comprises computing an average popularity score based on the popularity scores of the respective users of the plurality of users that are connected to the provider.

At 380, a recommender system is trained using the reputation scores of the plurality of providers, wherein the recommender system is used to automatically determine a provider recommendation.

In some embodiments, training the recommender system using the reputation scores of the plurality of providers comprises combining, for each provider of the plurality of providers, the reputation score with one or more of a change in yearly income of the provider, a change in net profit margin of the provider, a change in gross margin of the provider, a change in sales revenue of the provider, a category of the provider, or a geographical location of the provider to generate a set of features.

In some embodiments, additionally, the set of features is generated by further combining one or more of an average age of the users who interact with the provider, an average income of the users who interact with the provider, or a geographical location of the users who interact with the provider.

In some embodiments, the recommender system comprises one or more machine learning models, such as one or more of a linear regression model, a logistic regression model, a neural network, a reinforcement learning model, or a gradient-boosted tree.

### Example Application Server

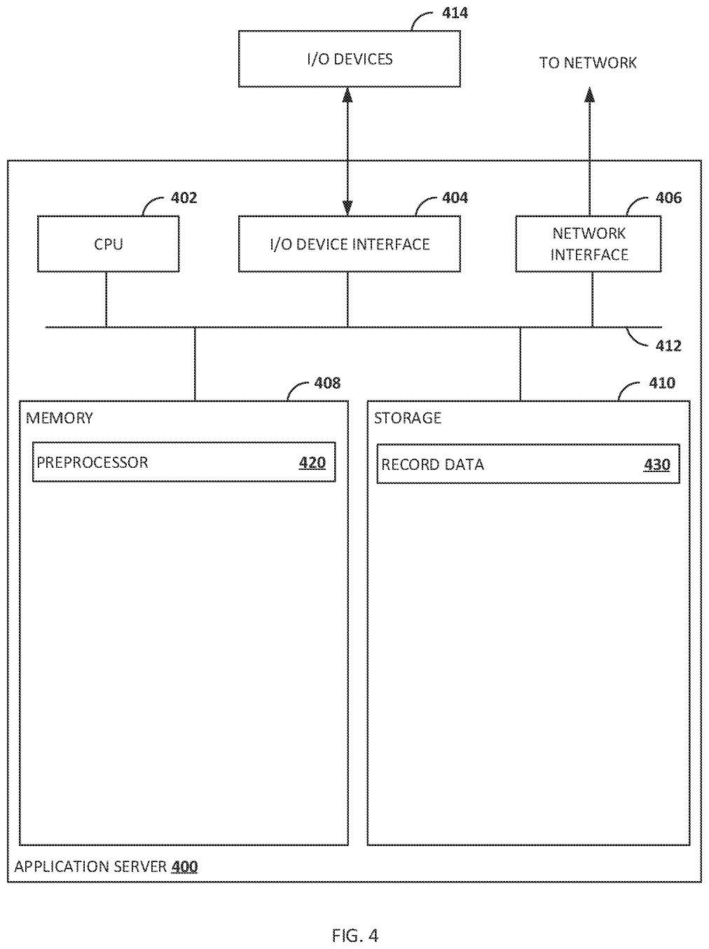

FIG. 4 depicts an example application server 400, which can be used to deploy preprocessor 100 of FIG. 1. As shown, application server 400 includes a central processing unit (CPU) 402, one or more input/output (I/O) device interfaces 404, which may allow for the connection of various I/O devices 414 (e.g., keyboards, displays, mouse devices, pen input, etc.) to application server 400, a network interface 406, a memory 408, a storage 410, and an interconnect 412.

CPU 402 may retrieve and execute programming instructions stored in memory 408. Similarly, CPU 402 may retrieve and store application data residing in memory 408. Interconnect 412 transmits programming instructions and application data, among CPU 402, I/O device interface 404, network interface 406, memory 408, and storage 410. CPU 402 is included to be representative of a single CPU, multiple CPUs, a single CPU having multiple processing cores, and the like. I/O device interface 404 may provide an interface for capturing data from one or more input devices integrated into or connected to application server 400, such as keyboards, mice, touchscreens, and so on. Memory 408 may represent a random access memory (RAM), while storage 410 may be a solid state drive, for example. Although shown as a single unit, storage 410 may be a combination of fixed and/or removable storage devices, such as fixed drives, removable memory cards, network attached storage (NAS), or cloud-based storage.

As shown, memory 408 includes preprocessor 420. Preprocessor 420 may be the same as or substantially similar to preprocessor 100 of FIG. 1.

As shown, storage 410 includes record data 430. Record data 430 may be the same as or substantially similar to record data 110 of FIG. 1.

It is noted that the components depicted in application server 400 are included as examples, and other types of computing components may be used to implement techniques described herein. For example, while memory 408 and storage 410 are depicted separately, components depicted within memory 408 and storage 410 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

1. A method, comprising:
receiving electronic record data indicating interactions between a plurality of users and a plurality of providers;
constructing a bipartite graph based on the interactions, wherein one set of nodes of the bipartite graph represents the plurality of users and another set of nodes of the bipartite graph represents the plurality of providers, and wherein an edge connects each respective provider of the plurality of providers with each respective user of the plurality of users that interacted with the respective provider in the interactions;
identifying, for each user of the plurality of users, a set of other users in the plurality of users, wherein each given user in the set of other users interacted with at least one common provider that the user interacted with in the interactions;
adding to the bipartite graph, for each user of the plurality of users, intra-user edges between the user and the set of other users in the plurality of users;
computing, for each respective intra-user edge of the intra-user edges, a weight of the respective intra-user edge based on a number of common providers shared by a pair of users of the plurality of users that is connected by the respective intra-user edge;
computing, for each respective user of the plurality of users, a popularity score, based on the weights of the intra-user edges connected to the respective user, wherein computing, for each respective user of the plurality of users, the popularity score comprises:
determining that a weight of a particular intra-user edge connected to the respective user does not meet a threshold weight;
setting the weight of the particular intra-user edge to zero; and
computing an average weight based on the weights of the intra-user edges connected to the respective user;
computing, for each respective provider of the plurality of providers, a reputation score based on the popularity scores of respective users of the plurality of users that are connected to the respective provider; and
training a recommender system using the reputation scores of the plurality of providers, wherein the recommender system is used to automatically determine a provider recommendation.

2. (canceled)

3. The method of claim 1, further comprising constructing an adjacency matrix, wherein one dimension of the adjacency matrix denotes the plurality of users and the other dimension denotes the plurality of providers.

4. The method of claim 1, wherein computing, for each respective provider of the plurality of providers, a reputation score based on the popularity scores of the respective users of the plurality of users that are connected to the respective provider comprises computing an average popularity score based on the popularity scores of the respective users of the plurality of users that are connected to the provider.

5. The method of claim 1, wherein training the recommender system using the reputation scores of the plurality of providers comprises:
combining, for each provider of the plurality of providers, the reputation score with one or more of a change in yearly income of the provider, a change in net profit margin of the provider, a change in gross margin of the provider, a change in sales revenue of the provider, a category of the provider, or a geographical location of the provider to generate a set of features.

6. The method of claim 5, wherein the set of features is generated by further combining one or more of an average age of the users who interact with the provider, an average income of the users who interact with the provider, or a geographical location of the users who interact with the provider.

7. The method of claim 1, wherein the recommender system comprises one or more of a linear regression model, a logistic regression model, a neural network, a reinforcement learning model or a gradient-boosted tree.

8. A system, comprising:
a memory including computer executable instructions; and
a processor configured to execute the computer executable instructions and cause the system to:
receive electronic record data indicating interactions between a plurality of users and a plurality of providers;
construct a bipartite graph based on the interactions, wherein one set of nodes of the bipartite graph represents the plurality of users and another set of nodes of the bipartite graph represents the plurality of providers, and wherein an edge connects each respective provider of the plurality of providers with each respective user of the plurality of users that interacted with the respective provider in the interactions;
identify, for each user of the plurality of users, a set of other users in the plurality of users, wherein each given user in the set of other users interacted with at least one common provider that the user interacted with in the interactions;
add to the bipartite graph, for each user of the plurality of users, intra-user edges between the user and the set of other users in the plurality of users;
compute, for each respective intra-user edge of the intra-user edges, a weight of the respective intra-user edge based on a number of common providers shared by a pair of users of the plurality of users that is connected by the respective intra-user edge;
compute, for each respective user of the plurality of users, a popularity score, based on the weights of the intra-user edges connected to the respective user, wherein to compute, for each respective user of the plurality of users, the popularity score, the processor is configured to:
determine that a weight of a particular intra-user edge connected to the respective user does not meet a threshold weight;
set the weight of the particular intra-user edge to zero; and
compute an average weight based on the weights of the intra-user edges connected to the respective user;
compute, for each respective provider of the plurality of providers, a reputation score based on the popularity scores of respective users of the plurality of users that are connected to the respective provider; and
train a recommender system using the reputation scores of the plurality of providers, wherein the recommender system is used to automatically determine a provider recommendation.

9. (canceled)

10. The system of claim 8, wherein the processor cause the system to further construct an adjacency matrix, wherein one dimension of the adjacency matrix denotes the plurality of users and the other dimension denotes the plurality of providers.

11. The system of claim 8, wherein computing, for each respective provider of the plurality of providers, a reputation score based on the popularity scores of the respective users of the plurality of users that are connected to the respective provider comprises computing an average popularity score based on the popularity scores of the respective users of the plurality of users that are connected to the provider.

12. The system of claim 8, wherein training the recommender system using the reputation scores of the plurality of providers comprises:
combining, for each provider of the plurality of providers, the reputation score with one or more of a change in yearly income of the provider, a change in net profit margin of the provider, a change in gross margin of the provider, a change in sales revenue of the provider, a category of the provider, or a geographical location of the provider to generate a set of features.

13. The system of claim 12, wherein the set of features is generated by further combining one or more of an average age of the users who interact with the provider, an average income of the users who interact with the provider, or a geographical location of the users who interact with the provider.

14. The system of claim 8, wherein the recommender system comprises one or more of a linear regression model, a logistic regression model, a neural network, a reinforcement learning model or a gradient-boosted tree.

15. A non-transitory computer readable medium comprising instructions to be executed in a computer system, wherein the instructions when executed in the computer system perform a method on a computing device, comprising:
receiving electronic record data indicating interactions between a plurality of users and a plurality of providers;
constructing a bipartite graph based on the interactions, wherein one set of nodes of the bipartite graph represents the plurality of users and another set of nodes of the bipartite graph represents the plurality of providers, and wherein an edge connects each respective provider of the plurality of providers with each respective user of the plurality of users that interacted with the respective provider in the interactions;
identifying, for each user of the plurality of users, a set of other users in the plurality of users, wherein each given user in the set of other users interacted with at least one common provider that the user interacted with in the interactions;
adding to the bipartite graph, for each user of the plurality of users, intra-user edges between the user and the set of other users in the plurality of users;
computing, for each respective intra-user edge of the intra-user edges, a weight of the respective intra-user edge based on a number of common providers shared by a pair of users of the plurality of users that is connected by the respective intra-user edge;
computing, for each respective user of the plurality of users, a popularity score, based on the weights of the intra-user edges connected to the respective user, wherein computing, for each respective user of the plurality of users, the popularity score comprises:
determining that a weight of a particular intra-user edge connected to the respective user does not meet a threshold weight;
setting the weight of the particular intra-user edge to zero; and
computing an average weight based on the weights of the intra-user edges connected to the respective user;
computing, for each respective provider of the plurality of providers, a reputation score based on the popularity scores of respective users of the plurality of users that are connected to the respective provider; and
training a recommender system using the reputation scores of the plurality of providers, wherein the recommender system is used to automatically determine a provider recommendation.

16. (canceled)

17. The non-transitory computer readable medium of claim 15, wherein the method further comprises constructing an adjacency matrix, wherein one dimension of the adjacency matrix denotes the plurality of users and the other dimension denotes the plurality of providers.

18. The non-transitory computer readable medium of claim 15, wherein computing, for each respective provider of the plurality of providers, a reputation score based on the popularity scores of the respective users of the plurality of users that are connected to the respective provider comprises computing an average popularity score based on the popularity scores of the respective users of the plurality of users that are connected to the provider.

19. The non-transitory computer readable medium of claim 15, wherein training the recommender system using the reputation scores of the plurality of providers comprises:
combining, for each provider of the plurality of providers, the reputation score with one or more of a change in yearly income of the provider, a change in net profit margin of the provider, a change in gross margin of the provider, a change in sales revenue of the provider, a category of the provider, or a geographical location of the provider to generate a set of features.

20. (canceled)

21. The method of claim 1, further comprising:
generating training data for one or more machine learning models of the recommender system, wherein the generating comprises combining, for each respective provider of the plurality of providers, the reputation score for the respective provider with one or more features related to the respective provider and one or more features related to the respective users of the plurality of users that interact with the respective provider; and
wherein the training comprises training the one or more machine learning models through a supervised learning process using the training data to automatically determine a provider recommendation, wherein the training comprises:
providing training inputs from the training data to the one or more machine learning models;
obtaining outputs from the one or more machine learning models based on the training inputs; and
iteratively adjusting parameters of the one or more machine learning models based on comparing the outputs to labels associated with the training inputs in the training data.
